(19) United States
(12) Patent Application Publication
(10) Pub. No.: US 2002/0104623 A1
(43) Pub. Date: Aug. 8, 2002

(54) Roller peel plate assembly for labeling machine

(76) Inventors: Dale C. Merrill, Hartford, VT (US); Ernest L. Goodwin, Enfield, NH (US)

Correspondence Address: Samuels, Gauthier & Stevens, Attn: William E. Hilton, 225 Franklin Street. Suite 3300, Boston, MA, 02110, US

(21) Appl. No.: 09/777,762

(22) Filed: Feb. 5, 2001

(51) Int. Cl. B32B 1/00

(52) U.S. Cl. 156/584

(57) ABSTRACT

A peel assembly is disclosed for use in a labeling system in which a continuous web of labels travels over a portion of the peel assembly to cause the web to separate from the labels. The peel assembly includes a roller support structure and a roller. The roller support structure includes a cavity, and the cylindrical roller is receivable in the roller support structure. As the web travels over the roller support structure, the roller may rotate with respect to the roller support and theweb is separated from a label as the web rotates with the cylindrical roller.

### PRIORITY INFORMATION

This application claims priority from provisional application Ser. No. 60/179,871 filed Feb. 2, 2000 and is incorporated herein by reference in its entirety.

### BACKGROUND OF THE INVENTION

The invention relates to the field of labeling machines in which labels are transferred from continuously moving backing strips via rotating feedrolls to articles such as food or medicine containers being conveyed through a labeling station. Such labels are typically provided on a web of material (e.g., release material), and are transferred to articles by permitting an exposed adhesive surface of each label to contact an article. The adhesive surface may be exposed either by having the non-adhesive side of the label held against a vacuum transfer drum (for example, see U.S. Pat. No. 5,415,716), or by having the label peel away from web at a peel surface (such as a peel plate) such that an article contacts the adhesive side of the label as the label is being separated from the web (for example, see U.S. Pat. No. 5,487,807).

Labeling machines in which labels are dispensed over a peel plate may be applied to articles directly or by a secondary device such as a print-and-apply applicator tool drum, vacuum belt, or other conventional application device. Labels used in such systems consist of a face stock that may be fully printed, partially pre-printed, or blank (for purposes of printing on demand). The face stock (or labels) are attached to a liner (typically a release liner), which is used to transport and dispense the labels. The web of liner material with labels is typically pre-wound on a roll, and a leading edge of the liner is fed through the labeling system. After the labels are separated from the liner, the remaining waste liner is re-wound on a rewind mechanism or other known device. The liner is constructed in such a way that the labels may be peeled off of the liner by hand or automatically using for example, a peel plate. The peeled label typically retains the adhesive as it travels to the article. The waste liner may be removed from the rewind system as desired, and may be discarded or recycled as scrap. The peel plate (over which the label is passed causing it to separate from the web), typically consists of a metal plate or other wear resistant material, and generally includes a sharp or small radius edge. A feed roll system is normally used to pull (or to push and pull) the web over the peel plate. The purpose of the peel plate is to cause the web scrap to be pulled away from each label as the label is passed over the peel plate. A motor or other generally known device(s) such as a stepper motor, AC/DC motor or servomotor may be used to drive the feed roll system together with a label gap sensor to precisely feed and position the label on the peel plate for application.

During operation of conventional labeling systems, web drag may occur due to friction experienced by the web as it moves through the system. Such drag may result in slippage, mis-labeling, web breakage, rapid peel plate wear, and unscheduled down time. Many factors may contribute to such drag, including the rotational friction of the numerous rollers, the material used to form the web, web path layout and drag bars. A significant amount of the drag, however, is thought to relate to the friction experienced by the web as it travels over the peel plate due to the required tension in the web at the tip of the peel plate. Various types of materials have been used for peel plates (as well as various coatings). Such materials and coatings include Satin Chrome, Electroless Nickel, Teflon, Composite Diamond, Titanium Nitride and Titanium Carbonitride. For example, tool steel with Satin Chrome may be used. Label liners are conventionally formed of paper, Mylar, film, polypropylene etc.

There is a need therefore, for a labeling machine that reduces web drag. There is a further need for a labeling machine that reduces web drag at the peel plate of a labeling system.

### SUMMARY OF THE INVENTION

The invention provides a peel assembly for use in a labeling system in which a continuous web of labels travels over a portion of the peel assembly to cause the web to separate from the labels. The peel assembly includes a roller support structure and a roller. The roller support structure includes a cavity, and the cylindrical roller is receivable in the roller support structure. As the web travels over the roller support structure, the roller may rotate with respect to the roller support and the web is separated from a label as the web rotates with the cylindrical roller. In various embodiments, the roller support structure is formed of ceramic, and the roller is formed of steel. In further embodiments, the roller is loosely captured at its axial ends by roller retainers.

### BRIEF DESCRIPTION OF THE DRAWINGS

The forgoing description of various embodiments of the invention may be further understood with reference to the accompanying drawings in which:

FIG. 1 shows an illustrative view of a conventional labeling system that includes a peel plate;

FIG. 2 shows another illustrative view of the conventional labeling system of FIG. 1;

FIG. 3 shows an enlarged illustrative view of a label peel assembly in accordance with an embodiment of the invention that may be used in the system of FIG. 1;

FIG. 4 shows a further enlarged illustrative view a portion of the peel assembly shown in FIG. 3 without the web of labels;

FIG. 5 shows an exploded view of the portion of the peel assembly shown in FIG. 4; and

FIG. 6 shows another further enlarged exploded view of a portion of the peel assembly shown in FIG. 5.

The drawings are referenced for illustrative purposes only and are not necessarily to scale.

### DETAILED DESCRIPTION OF THE INVENTION

The invention provides for the use of a roller at the outer edge of a peel plate. Such a roller should have a sufficiently small radius to permit labels to separate from the web as the web travels around the roller. The tensile forces that exist in a web during operation of a label machine, however, are typically high. It has been discovered that if a small radius roller is mounted at the edge of a peel plate and is rotatably retained at its longitudinal ends only, then there is a significant chance that the axle about which the roller rotates may snap under the tensile forces of the web and/or the roller may bend. It has further been discovered that a roller may be used that is loosely retained at its ends, and is supported along the longitudinal length of the exterior of the roller.

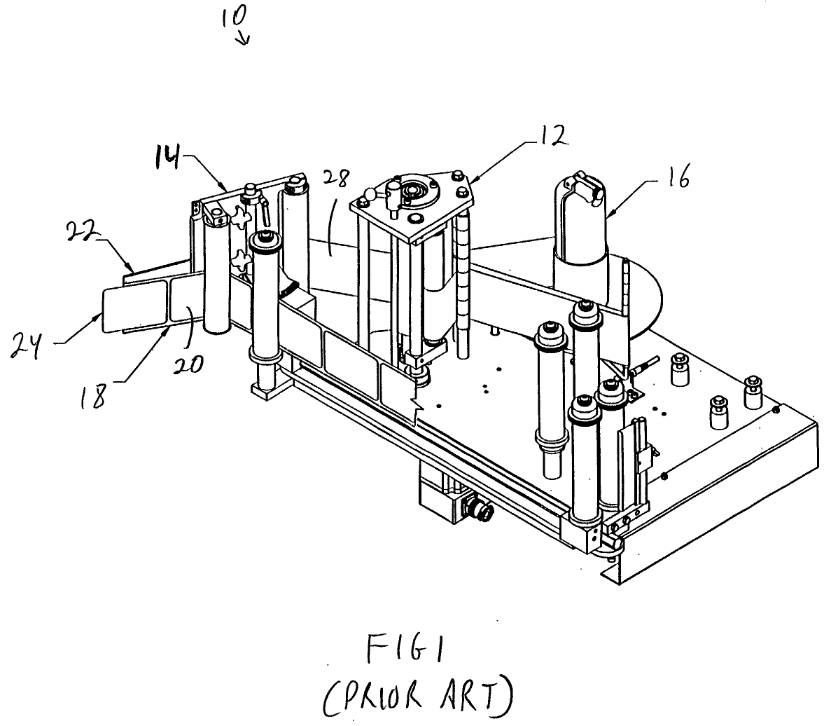

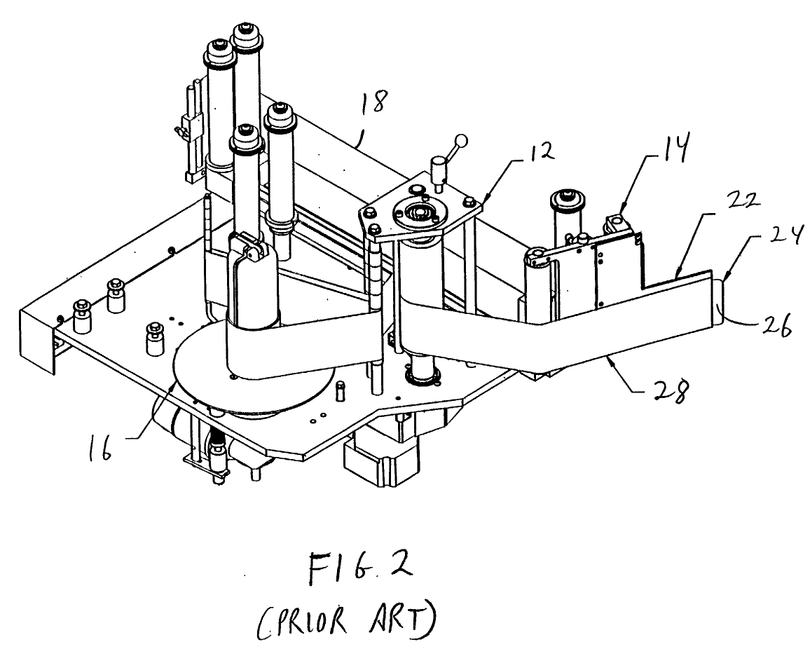

As shown in FIGS. 1 and 2, a conventional labeling system 10 includes a peel assembly 14, feed roll assembly 12, and a rewind assembly 16. Generally, a web 18 of labels 20 is drawn from a supply reel (not shown) around the narrowed end area 22 of the peel assembly 14 as shown. During operation, the leading edge 24 of each label 20 is applied to an article using the contact adhesive 26 that is included on one side of the labels 20. The waste portion 28 of the web (without the labels) is then rewound one a rewind spool at the rewind assembly 16. Metered movement of the web through the system is achieved by the feed roll assembly 12, which then passes the waste web material to the rewind assembly 16 where it is drawn about a rewind roll.

As shown in FIG. 3, a peel plate assembly 30 in accordance with an embodiment of the invention includes an end portion 32 about which a web travels while in tension, causing labels 24 to be separated from the remaining waste web 28. The waste web 28 is then drawn around roller 34 toward a feed roll assembly, and eventually to a rewind roll.

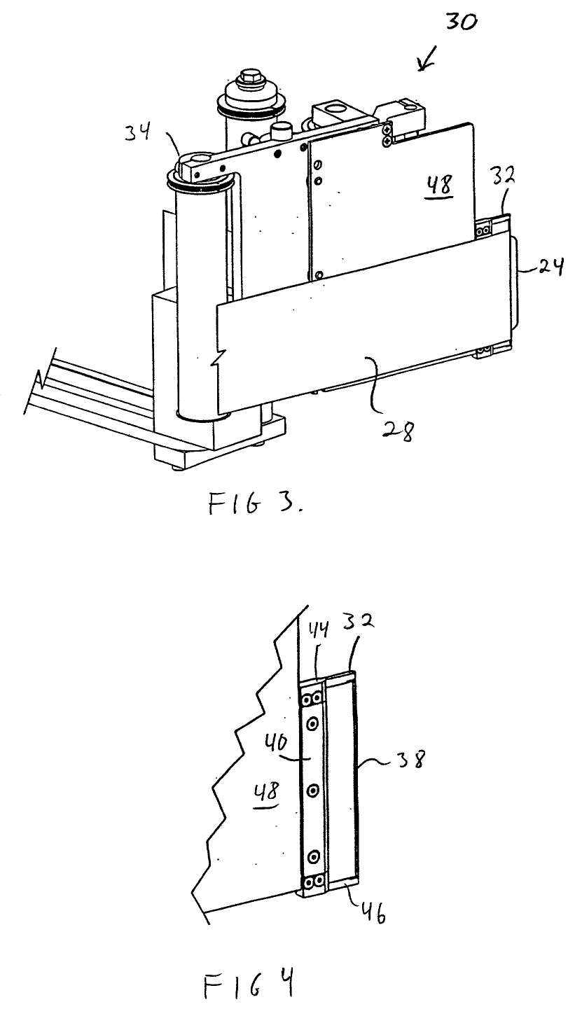

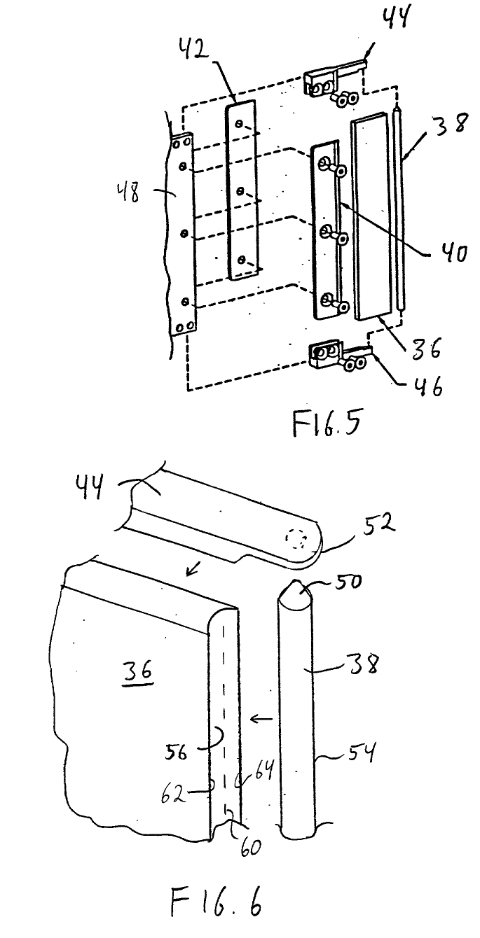

As shown in FIGS. 4 and 5 (in which the waste web and labels are not shown), the end portion 32 of the peel plate assembly includes a peel plate 36 and a roller 38. The peel plate 36 is captured between retaining bars 40 and 42, and the roller 38 is captured between roller retainers 44 and 46 as further shown in FIG. 5. The retaining bars 40 and 42, and roller retainers 44 and 46 are mounted on support plate 48.

As further shown in FIG. 6, the roller 38 includes conically shaped ends 50 that are each loosely received in retaining recesses 52 in the roller retainers 44 and 46. The outer cylindrical portion 54 of the roller 38 is received by a cavity 56 in the peel plate 36 as shown in FIG. 6. The cavity 56 may be formed by a wide variety of structures, including V-shaped grooves, U-shaped grooves, squared cornered-grooves, or even structures that do not form a continuous shape along the entire longitudinal length of the roller, as long as the surface is deeper in the central region 60 with respect the outer edges regions 62 and 64.

In various embodiments, the peel plate may be formed of ceramic material, plastic, or metal, and the roller may be formed of ceramic material, plastic or metal, or any other material that serves as an efficient wear surface. In a preferred embodiment, the peel plate is formed of a ceramic material, and the roller is formed of a steel rod or shaft. Unlike conventional peel plate designs in which a web is dragged over a sharp or radius edge, the steel roller freely rotates in a machined concavity or groove in the ceramic plate. The rolling action has been found to significantly reduce friction and thus tension on the web.

The material used to form a steel roller may be commercial drill rod having a radius that replicates the radius of the conventional peel plate that is to be replaced with a peel apparatus of the invention. Other possible materials include ground polished steel shafting, case hardened steel, etc. The purpose of the roller retainers 44 and 46 is to keep the roller 3 8 from falling out of the cavity 56 in the plate 36. During operation, therefore, the roller 38 experiences minimal resistance at the roller retainers 44 and 46, while the primary load while is received at the interface of the cavity 56 and the outer cylindrical surface of the roller 38. Various dimensions may, of course, be adjusted to accommodate different sizes of webs and labels. The support plate 48 may be formed of steel or plastic, and may aid in protecting the ceramic plate 36 from bending loads or potential breakage during handling and operation.

Certain benefits of using a ceramic peel plate in accordance with an embodiment of the invention include 1) a decrease in the potential for the buildup of static charge since the ceramic does not conduct static charge to the point of dispensing; 2) a decrease in the amount of heat generated during operation due to the low coefficient of friction between the components; and 3) a decrease in the conductivity of thermal energy. Certain labels and web materials may generate static charges during operation. Such static buildup (or even discharge) may adversely affect operation of the labeling system. Roller peel plate apparatus of the invention may be used on conventional labeling machines, and may provide improved registration accuracy, less web breakage, increased speed, and increased peel plate longevity.

Those skilled in the art will appreciate that numerous modifications and variations may be made to the above disclosed embodiments without departing from the spirit or scope of the invention.

What is claimed is:

1. A peel assembly for use in a labeling system in which a continuous web of labels travels over a portion of the peel assembly to cause the web to separate from the labels, said peel assembly comprising:
a roller support structure including a cavity; and
a cylindrical roller receivable in said roller support structure such that as the web travels over the roller support structure, said roller may rotate with respect to said roller support and the web is separated from a label as the web rotates with said cylindrical roller.

2. A peel assembly as claimed in claim 1, wherein said peel assembly further includes roller retainers for loosely retaining end portions of said cylindrical roller.

3. A peel assembly as claimed in claim 1, wherein said roller support structure includes ceramic material.

4. A peel assembly as claimed in claim 1, wherein said cylindrical roller includes a steel rod.

5. A peel assembly as claimed in claim 1, wherein said roller includes conically shaped ends.

6. A peel assembly as claimed in claim 2, wherein said roller retainers are mounted on a support plate.

7. A peel assembly as claimed in claim 1, wherein said roller support structure is captured between opposing retaining bars.

8. A peel assembly as claimed in claim 7, wherein said retaining bars are mounted on a support plate.

9. A peel assembly for facilitating the separation of labels from a web in a labeling system, said peel assembly comprising:
a rotatable cylindrical roller having a longitudinal length and a diameter that is sufficiently small that when the web travels with said roller as it rotates, labels on the web are caused to separate from the web;
a roller support structure against which at least a portion of the longitudinal length of the cylindrical roller may contact the roller support surface as the roller is rotated; and
roller retainers for loosely retaining end portions of said cylindrical roller.

10. A peel assembly as claimed in claim 9, wherein said roller support material includes ceramic material.

11. A peel assembly as claimed in claim 9, wherein said cylindrical roller includes a steel rod.

12. A peel assembly as claimed in claim 9, wherein said cylindrical roller includes conically shaped ends.

13. A peel assembly as claimed in claim 9, wherein said roller retainers are mounted on a support plate.

14. A peel assembly as claimed in claim 9, wherein said roller support structure is captured between opposing retaining bars.

15. A peel assembly as claimed in claim 14, wherein said retaining bars are mounted on a support plate.

16. A peel assembly for facilitating the separation of labels from a web in a labeling system, said peel assembly comprising:
a rotatable metal cylindrical roller having a longitudinal length and a diameter that is sufficiently small that when the web travels with said roller as it rotates, labels on the web are caused to separate from the web;
a ceramic plate including a cavity against which at least a portion of the longitudinal length of the cylindrical roller may contact the plate as the roller is rotated; and
roller retainers for loosely retaining end portions of said cylindrical roller.
